(19) United States
(12) Patent Application Publication
(10) Pub. No.: US 2015/0175935 A1
(43) Pub. Date: Jun. 25, 2015

(54) DISPOSABLE CANDLE GEL INSERT MOLD

(71) Applicant: Kimberly L. Moyal, Arlington Heights, IL (US)

(72) Inventor: Kimberly L. Moyal, Arlington Heights, IL (US)

(21) Appl. No.: 14/576,816

(22) Filed: Dec. 19, 2014

Related U.S. Application Data
(60) Provisional application No. 61/918,284, filed on Dec. 19, 2013.

(51) Int. Cl. C11C 5/02

(52) U.S. Cl. CPC C11C 5/023

(57) ABSTRACT

A candle gel insert mold including an arcuate side wall having a minor periphery, a major periphery, two longitudinal edges, each connecting one end of the minor periphery and one end of the major periphery forming a longitudinal end of the side wall, a slit disposed on a longitudinal end, a securing tab disposed on another longitudinal end and a base extending from the minor periphery. The side wall is configured to be curled longitudinally such that the securing tab is capable of being inserted within the slit to secure the two longitudinal ends to form a cup. The base is capable of being bent along the minor periphery to form a bottom support for the cup. The cup is capable of receiving molten refill and when the molten refill has solidified, the cup is capable of being torn and removed from the solidified refill.

### PRIORITY CLAIM AND RELATED APPLICATIONS

This non-provisional application claims the benefit of priority from provisional application U.S. Ser. No. 61/918,284 filed on Dec. 19, 2013. Said application is incorporated by reference in its entirety.

### BACKGROUND OF THE INVENTION

1. The Field of the Invention

The present invention is directed generally to a candle gel insert mold. More specifically, the present invention is directed to a disposable candle gel insert mold.

2. Background Art

U.S. Pat. No. 6,435,694 to Bell et. al. (hereinafter Bell) discloses a composite structure, including an outer portion and an inner portion. The outer portion is made of a gel composition. The outer portion may be set in an outer receptacle or stand alone. The outer portion of the candle has a recess into which the inner portion is positioned. The inner portion typically contains at least one wick. The inner portion may be contained in an inner receptacle, which is then placed into the recess in the outer portion of the candle. The inner receptacle is clear, and, is concealed by the outer portion. The inner receptacle or the inner portions, or both, are replaceable. The inner portion may be formed from wax or gel or other suitable candle body material. The outer portion may contain a variety of decorative objects or may be designed to produce a variety of decorative effects. The decorative effect imparted by the candle takes advantage of the visual effect of having an inner and outer portion. When a wick in the inner portion is lit, light from the inner portion passes through the outer portion of the candle and enhance decorative effects dispersed in the outer candle body. The inner portion may be replaceable. The present candle gel insert mold represents a structure effective for holding the form of a molten insert during its curing process to become a solid insert which may be placed in the inner receptacle of Bell's structure.

U.S. Pat. No. 6,059,564 to Morris (hereinafter Morris) discloses a wax body made of a translucent wax forms a candle holder. A glass holder is embedded in the wax body to receive a candle. The candle is either formed within the glass holder or is formed separately as a replacement candle for the glass holder. A decorative paper is secured to the wax body exterior. A translucent wax layer covers the exterior of the decorative paper. Similar to Bell, Morris's glass holder may also be used to receive an insert/candle formed outside of the glass holder. When lit, the solid insert again becomes molten and conforms to the shape of the glass holder.

Two conventional methods have been used to fill candle holders. First, molten gel may be poured into an inner receptacle or holder directly. Molten gel is possible with heating of a solid gel. Upon cooling, the molten gel just poured becomes solidified. A wick is held or supported in the inner receptacle until such time as the gel becomes sufficiently solidified to support the wick in place. Second, an insert may be pre-formed outside of the inner receptacle. Pre-formed inserts are a convenient means for refilling the inner receptacles as pre-formed inserts are solids and sturdy to the touch. It shall be noted that at room temperature, gel candle becomes sufficiently solid to handle but does not retain the level of hardness as wax candles. Solidified gel inserts retain the gelatinous consistencies and quite soft. Molten refills are inconvenient to handle, especially for home users as it requires heating and transfer of a hot gel from one container to another. A conventional cup may be used as a container to hold molten refills. However, inner portions of the cup must be suitably coated with a release agent such that a formed insert may be removed from the cup. Again, a wick is supported in the cup's cavity until such time the refill has sufficiently solidified for handling. Even when first coated with suitable amount of release agent, the tackiness of the insert remains sufficiently strong to retain the insert in the cup. Therefore, an insert is difficult to be removed without destroying the insert or tearing the insert into separate pieces. The Applicant discovered that by providing a flexible mold, the mold may be peeled away from the insert, enhancing the release of the insert from its mold, instead of attempting to remove the insert from the mold. The Applicant further discovered that by providing a mold capable of being torn away and removed from the refill, the refill can remain intact, both retaining its appeal for the consumers, the integrity of the refill and ensuring that no refill materials are lost while removing the refills from their molds.

Thus, there arises a need for a flexible candle gel insert mold that can be used to form a candle gel insert without any release agents and one which can be removed without causing damage to the candle gel insert.

### SUMMARY OF THE INVENTION

The present invention is directed toward a candle gel insert mold including an arcuate side wall, the side wall having a minor periphery, a major periphery and two longitudinal edges, each connecting one end of said minor periphery and one end of said major periphery forming a longitudinal end of the side wall, a slit disposed on a longitudinal end of the side wall, a securing tab disposed on another longitudinal end of the side wall and a base extending from the minor periphery where the side wall is configured to be curled longitudinally such that the securing tab is capable of being inserted within the slit to secure the two longitudinal ends to form a cup. The base is capable of being bent along the minor periphery to form a bottom support for the cup. The cup is capable of receiving molten refill and when the molten refill has solidified, the cup is capable of being torn and removed from the solidified refill and the base is configured to sufficiently conform to the minor periphery of the cup.

The securing tab is configured to extend from one of the two longitudinal ends from a minimum width to a maximum width. The ratio of the maximum width to the minimum width is at least about 3/2.

The side wall, securing tab and base are constructed from a single continuous sheet of Solid Bleach Sulfate (SBS) cardboard including a thickness of about 0.1 point.

Accordingly, it is a primary object of the present invention to provide a candle gel insert mold capable of being removed without jeopardizing the integrity of the candle gel insert formed within the candle gel insert mold.

It is another object of the present invention to provide a candle gel insert mold which does not require any release agents for a candle gel insert to be removed from its candle gel insert mold.

It is yet another object of the present invention to provide a candle gel insert mold which can be configured into the shape of a conventional cup.

It is yet another object of the present invention to provide a candle gel insert mold which can be manufactured cost effectively.

It is yet another object of the present invention to provide a candle gel insert mold capable of being fabricated from a flat sheet and therefore a plurality of the molds can be prepared expediently and without undue effort, e.g., using only one or few passes.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a top perspective view of an embodiment of the present insert mold, depicting the present insert mold being used to hold and form a candle insert.

FIG. 2 is a top perspective view of an embodiment of the present insert mold, depicting the present insert mold being used to hold and form candle insert and the mold is assembled in a configuration different than that shown in FIG. 1.

FIG. 3 is a plan view of one embodiment of the present insert mold in its unfurled configuration.

FIG. 4 is a side view of the embodiment of the present insert mold as shown in FIG. 3 in its unfurled configuration as viewed when facing the minor periphery of the mold.

FIG. 5 is a side view of the embodiment of the present insert mold as shown in FIG. 3 in its unfurled configuration as viewed when facing the major periphery of the mold.

FIG. 6 is a partial plan view of a blank sheet where a plurality of molds are being fabricated from the same sheet.

FIG. 7 is a plan view of another embodiment of the present insert mold where the base is provided separately from the side wall.

FIG. 8 is a plan view of yet another embodiment of the present insert mold where the base of the embodiment of FIG. 7 is not being used.

FIG. 9 is a perspective view of a formed refill being dropped into a candle container.

FIG. 10 is a plan view of another embodiment of the present insert mold in its unfurled configuration.

### PARTS LIST

2—mold with base
4—mold without base
6—side wall
8—base
10—slit
12—securing tab
14—seam
16—refill flow
18—wick
20—refill
22—maximum width of securing tab
24—minimum width of securing tab
26—distance to base mounting location from one longitudinal edge of side wall
28—distance to base mounting location from another longitudinal edge of side wall
30—minor periphery
32—longitudinal edge
34—major periphery
36—blank sheet
38—cut
40—candle container
42—long side

### Particular Advantages of the Invention

The present mold eliminates the need for application of a release agent on a mold that is rigid, not designed to be disposable or otherwise not capable of being torn away from an insert formed within the mold. The present mold is flexible and capable of being torn away from the insert it holds, thereby reducing the likelihood that the insert gets damaged while the insert is being removed from the mold. The present mold can be unfurled easily from the formed insert compared to conventional means for holding inserts.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

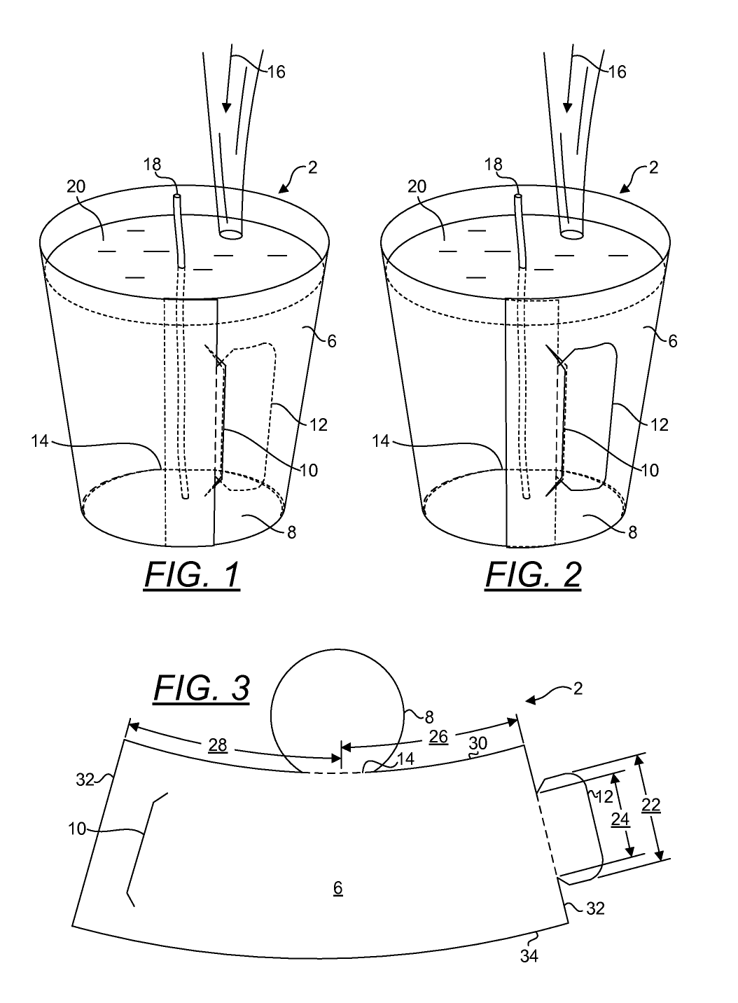

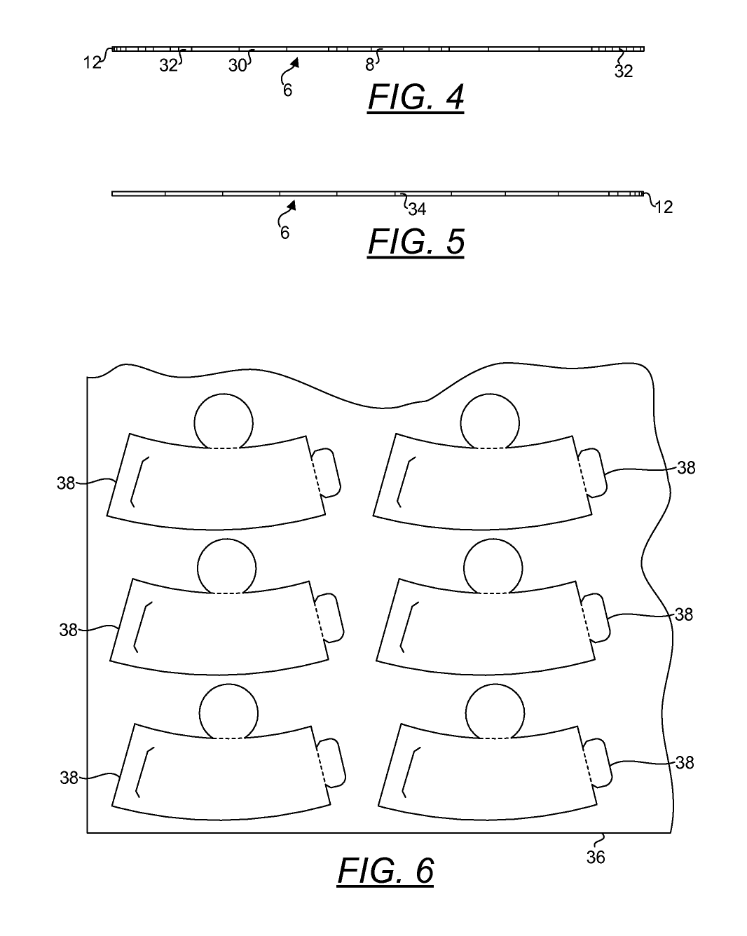

FIG. 1 is a top perspective view of an embodiment of the present insert mold, depicting the present insert mold 2 being used to hold and form candle insert. FIG. 2 is a top perspective view of an embodiment of the present insert mold, depicting the present insert mold 2 being used to hold and form candle insert and the mold is assembled in a configuration different than that shown in FIG. 1. FIG. 3 is a plan view of one embodiment of the present insert mold 2 in its unfurled configuration. FIG. 4 is a side view of the embodiment of the present insert mold as shown in FIG. 3 in its unfurled configuration as viewed when facing the minor periphery of the mold. FIG. 5 is a side view of the embodiment of the present insert mold as shown in FIG. 3 in its unfurled configuration as viewed when facing the major periphery of the mold. Referring to FIG. 1, a flow of refill 16 is being poured into the insert mold 2. In one example, the refill is essentially an edible grade white mineral oil having a viscosity of about 543 Centipoise (CPS) while in its molten state at about 110 degrees C. (as determined using viscosity testing method ASTM D2983). Upon being poured in the insert mold 2, the mineral oil solidifies as its temperature drops to the room temperature. The insert mold 2 includes an arcuate side wall 6 and a base 8. The side wall 6 is essentially made of a sheet of the shape of an arc. The side wall 6 includes a minor periphery 30 and two longitudinal edges 32, a slit 10 disposed on one of the two longitudinal edges 32, a securing tab 12 disposed on another of the two longitudinal edges 32.

A base 8 extends from the minor periphery 30. The side wall 6 is configured to be curled longitudinally such that the securing tab 12 is capable of being inserted within the slit 10 to secure the two longitudinal edges to form a cup. There are two ways to insert the securing tab 12 in the slit 10. In a first way, as shown in FIG. 1, the longitudinal io end on which the securing tab 12 is disposed, is brought under the longitudinal end on which the slit 10 is disposed before the securing tab 12 gets inserted in the slit 10. In a second way, as shown in FIG. 2, the longitudinal end on which the securing tab 12 is disposed, is brought over the longitudinal end on which the slit 10 is disposed before the securing tab 12 gets inserted in the slit 10. As the tab 12 in FIG. 2 does not come in contact with the insert, the Applicant finds that the mold 2 shown in FIG. 2 can be removed more easily from the insert. In order to form the cup shaped mold 2, the base 8 is bent along the minor periphery 30 at seam 14 to form a bottom support for the cup where the periphery of the base 8 sufficiently conforms to the minor periphery 30 of the cup. The cup is capable of receiving molten refill 20 and when the molten refill has solidified, the cup is capable of being torn and removed from the solidified refill. A wick 18 is held or supported substantially centrally within the cup until such time as the insert becomes sufficiently solidified to support the wick 18 in place. In one embodiment, the base 8 is positioned substantially centrally along the minor periphery 30 such that the distance 26 of the base 8 from one longitudinal edge of the side wall 6 is substantially the same as the distance 28 of the base from the other longitudinal edge of the side wall 6.

In one embodiment, the side wall 6, securing tab 12 and base 8 are constructed from a single continuous sheet of Solid Bleach Sulfate (SBS) cardboard and includes a thickness of about 0.1 point. In one embodiment, the present molds 2, 4 are mass produced. FIG. 6 is a partial plan view of a blank sheet where a plurality of molds are being fabricated from the same sheet. A large sheet of cardboard is first made available and placed upon a flat hard surface. Each mold 2 is formed from the sheet by die cutting the blank sheet 36. Multiple dies may be used at once to cut multiple molds 2 from the sheet at once. Cuts 38 may alternatively be made using laser cutting to cut molds 2 from the blank sheet 36. Each mold 2 is then folded longitudinally to form a cup with its securing tab 12 inserted through its slit 10, thereby securing the cup in its erected form. Its base 8 is then folded along the minor periphery 30 of the mold such that a support surface is provided to seal the base of the cup. The process of erecting each cup may be automated or performed by hand. The securing tab is configured to extend from one of the two longitudinal edges from a minimum width 24 to a maximum width 22. In one embodiment, the ratio of the maximum width to the minimum width is at least about 3/2.

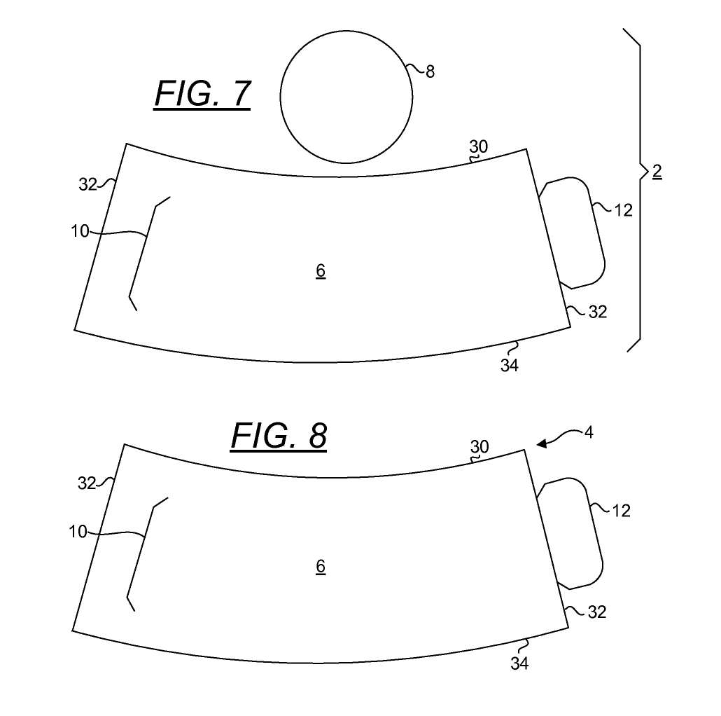

FIG. 7 is a plan view of a second embodiment of the present insert mold in its unfurled configuration. In this embodiment, the side wall 6 is provided separately from the base 8. In order to form a mold, the side wall is first erected. The base 8 is then dropped into the cup such that the base is disposed at the bottom of the cup. Refill is then poured into the cup such that an insert can be formed, much like the means by which an insert is formed with the previous embodiment.

In yet another example as shown in FIG. 8, an individually portioned base is not used. FIG. 8 is a plan view of yet another embodiment of the present insert mold 4 where the base of the embodiment of FIG. 7 is not being used. In this configuration, a formed cup is simply placed atop a non-stick surface, e.g., glass, cardboard, etc. Upon forming an insert, the insert is first detached carefully from the non-stick surface before its side wall is peeled away or removed from the insert.

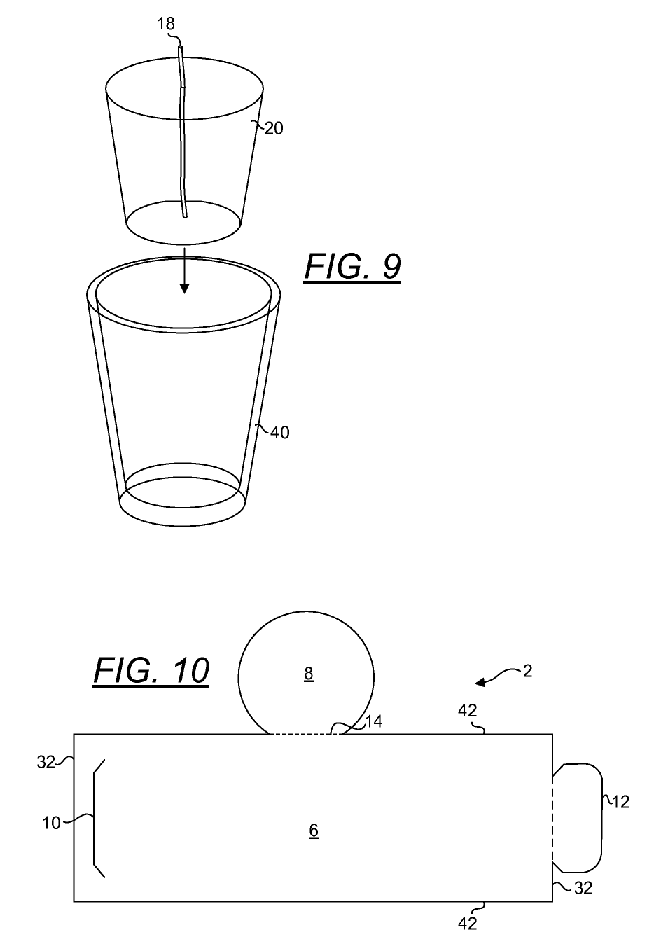

FIG. 9 is a perspective view of a formed refill being dropped into a candle container. A refill 20 is formed generally in the shape of a cup shape with the vertical profile of refill narrows from top to bottom. The precise shape of the refill in conforming to the cavity of the container 40 is unimportant as, in its molten state during its first use, the refill will melt and conform to the shape of the container it is disposed. With the cup shape profile, however, it is generally easier to center the wick 18 within the container as a refill 20 generally fits better in the container 40 in its solidified state. There is yet provided another embodiment of the present mold as shown in FIG. 10 where the side wall 6 is substantially rectangular and it includes long sides 42 connected to longitudinal edges 32. In this embodiment, an erected mold takes the shape of a cylinder and hence the formed refill will also take on this shape. The base 8 may also be separately provided as disclosed elsewhere herein.

The detailed description refers to the accompanying drawings that show, by way of illustration, specific aspects and embodiments in which the present disclosed embodiments may be practiced. These embodiments are described in sufficient detail to enable those skilled in the art to practice aspects of the present invention. Other embodiments may be utilized, and changes may be made without departing from the scope of the disclosed embodiments. The various embodiments can be combined with one or more other embodiments to form new embodiments. The detailed description is, therefore, not to be taken in a limiting sense, and the scope of the present invention is defined only by the appended claims, with the full scope of equivalents to which they may be entitled. It will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used. The scope of the embodiments should be determined with reference to the appended claims, along with the full scope of equivalents to which such claims are entitled.

I claim:

1. A candle gel insert mold comprising:
(a) an arcuate side wall having a minor periphery, a major periphery and two longitudinal edges, each edge connecting one end of said minor periphery and one end of said major periphery forming a longitudinal end of said arcuate side wall;
(b) a slit disposed on one of said two longitudinal ends; and
(c) a securing tab disposed on the other one of said two longitudinal ends,
wherein said side wall is configured to be curled longitudinally such that said securing tab is capable of being inserted within said slit to secure said two longitudinal ends to form a cup capable of receiving molten refill and when the molten refill has solidified and said cup is capable of being torn and removed from the solidified refill.

2. The candle gel insert mold of claim 1, further comprising a base extending from said minor periphery, wherein said base is capable of being bent along said minor periphery to form a bottom support for said cup to contain the refill within said cup.

3. The candle gel insert mold of claim 2, wherein said side wall, securing tab and base are constructed from a single continuous sheet of Solid Bleach Sulfate (SBS) cardboard.

4. The candle gel insert mold of claim 1, wherein said securing tab is configured to extend from one of said two longitudinal edges from a minimum width to a maximum width and wherein the ratio of said maximum width to said minimum width is at least about 3/2.

5. The candle gel insert mold of claim 1, wherein said side wall and securing tab are constructed from Solid Bleach Sulfate (SBS) cardboard.

6. The candle gel insert mold of claim 1, further comprising a base useful for forming a bottom support for said cup to contain the refill within said cup.

7. A candle gel insert mold comprising:
(a) an arcuate side wall having a minor periphery, a major periphery and two longitudinal edges, each edge connecting one end of said minor periphery and io one end of said major periphery forming a longitudinal end of said arcuate side wall;
(b) a slit disposed on one of said two longitudinal ends;
(c) a securing tab disposed on the other one of said two longitudinal ends; and
(d) a base extending from said minor periphery,
wherein said side wall is configured to be curled longitudinally such that said securing tab is capable of being inserted within said slit to secure said two longitudinal ends to form a cup, said base is capable of being bent along said minor periphery to form a bottom support for said cup, said cup is capable of receiving molten refill and when the molten refill has solidified, said cup is capable of being torn and removed from the solidified refill and said base is configured to sufficiently conform to said minor periphery of said cup.

8. The candle gel insert mold of claim 7, wherein said securing tab is configured to extend from one of said two longitudinal edges from a minimum width to a maximum width and wherein the ratio of said maximum width to said minimum width is at least about 3/2.

9. The candle gel insert mold of claim 7, wherein said side wall, securing tab and base are constructed from a single continuous sheet of Solid Bleach Sulfate (SBS) cardboard.

10. A candle gel insert mold comprising:
(a) a rectangular side wall having a pair of long sides and a pair of longitudinal edges, each edge connected at one end to one end of a long side forming a longitudinal end of said rectangular side wall;
(b) a slit disposed on one said two longitudinal ends; and
(c) a securing tab disposed on the other one of said two longitudinal ends,
wherein said side wall is configured to be curled longitudinally such that said securing tab is capable of being inserted within said slit to secure said two longitudinal ends to form a cup capable of receiving molten refill and when the molten refill has solidified and said cup is capable of being torn and removed from the solidified refill.

11. The candle gel insert mold of claim 10, further comprising a base extending from one of said long sides, wherein said base is capable of being bent along said one of said long sides to form a bottom support for said cup to contain the refill within said cup.

12. The candle gel insert mold of claim 11, wherein said side wall, securing tab and base are constructed from a single continuous sheet of Solid Bleach Sulfate (SBS) cardboard.

13. The candle gel insert mold of claim 10, wherein said securing tab is configured to extend from one of said two longitudinal ends from a minimum width to a maximum width and wherein the ratio of said maximum width to said minimum width is at least about 3/2.

14. The candle gel insert mold of claim 10, wherein said side wall and securing tab are constructed from Solid Bleach Sulfate (SBS) cardboard.

15. The candle gel insert mold of claim 10, further comprising a base useful for forming a bottom support for said cup to contain the refill within said cup.
